(19) United States
(12) Patent Application Publication
(10) Pub. No.: US 2005/0141898 A1
(43) Pub. Date: Jun. 30, 2005

(54) System for all-optical clock recovery

(76) Inventors: Dae Su Yee, Daejeon-city (KR); Young Ahn Leem, Daejeon-city (KR); Kyung Hyun Park, Daejeon-city (KR); Dong Churl Kim, Daejeon-city (KR); Sung Bock Kim, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/004,368

(22) Filed: Dec. 3, 2004

(30) Foreign Application Priority Data
Dec. 24, 2003 (KR) 2003-96221

(51) Int. Cl. H04B 10/00

(52) U.S. Cl. 398/155

(57) ABSTRACT

Provided is a system for all-optical clock recovery that can reduce a pattern effect and timing jitter of an optical clock. The system includes an optical signal controller that controls the magnitude and polarization state of an optical signal, a laser unit that receives the optical signal output from the optical signal controller and outputs an optical clock, and an optical regeneration loop that controls the phase, polarization, and magnitude of the optical clock output from the laser unit so as to provide the laser unit with the optical clock, the phase, polarization, and magnitude of which are controlled, and the optical signal output from the optical signal controller.

### BACKGROUND OF THE INVENTION

This application claims the priority of Korean Patent Application No. 2003-96221, filed on Dec. 24, 2003, in the Korean Intellectual Property Office, the disclosure of which is incorporated herein in its entirety by reference.

1. Field of the Invention

The present invention relates to an all-optical clock recovery device, and more particularly, to a system for all-optical clock recovery that is essential in optical signal processing such as 3R regeneration and demultiplexing.

2. Description of the Related Art

A clock signal can be obtained electrically and optically. One such optical method is an all-optical method using injection locking.

FIGS. 1 and 2 are block diagrams schematically showing embodiments of a conventional all-optical clock recovery device using injection locking.

Referring to FIGS. 1 and 2, the conventional all-optical clock recovery device includes an optical signal controller 10, a laser unit 20, and an optical clock output unit 30.

The optical signal controller 10 includes a variable optical amplifier 12 that amplifies optical signals λ_{σ} to a predetermined magnitude, a first optical bandpass filter (OBPF) 14 that selects an optical signal λ_{S} from the amplified optical signals λ_{σ}, and a polarization controller (PC) 16 that controls the polarization state of the optical signal λ_{S}. Here, the PC 16 may or may not be required depending on the type of laser used.

The laser unit 20 includes a laser 25 and a transmission unit (27a or 27b) that transmits an optical clock λ_{C} from the laser 25 according to the input and output ports of the laser 25. The transmission unit (27a or 27b) is disposed on a front end of the laser 25. In a case where the input and output ports of the laser 25 are the same, an optical circulator (OC) 27a is used as the transmission unit, and in a case where the input and output ports are different, an optical isolator (OI) 27b is used as the transmission unit. The transmission unit (27a or 27b) transmits the optical clock λ_{C} from the laser to the optical clock output unit 30 and prevents them from returning to the optical signal controller 10.

The optical clock output unit 30 includes an optical amplifier 32 that amplifies the optical clock λ_{C} from the laser unit 20, and a second OBPF 35 that outputs only the optical clock λ_{C} among the optical signal λ_{S} and the optical clock λ_{C}.

Since an optical signal, not an optical pulse, is injected into the laser, the optical clock output from the above system may have a pattern effect and a relatively large timing jitter.

### SUMMARY OF THE INVENTION

According to an aspect of the present invention, there is provided a system for all-optical clock recovery including: an optical signal controller that controls the magnitude and the polarization state of an optical signal, a laser unit that receives the optical signal output from the optical signal controller and outputs an optical clock, and an optical regeneration loop that controls the phase, polarization, and strength of the optical clock output from the laser unit so as to provide the laser unit with the optical clock, the phase, polarization, and strength of which are controlled, and the optical signal output from the optical signal controller.

The laser unit may include a laser and a unit for transmitting the optical clock output from the laser to the optical regeneration loop.

The laser may be a passively mode-locked laser diode, a mode-locked fiber ring laser, or a self-pulsating laser diode.

If the input and output ports of the laser are the same, the unit for transmitting the optical clock may be an optical circulator. If the input and output ports of the laser are different, the unit for transmitting the optical clock may be an optical isolator.

The optical regeneration loop may include a variable optical amplifier that controls the magnitude of the optical clock output from the laser unit, an optical bandpass filter that passes only the optical clock among the optical signal and the optical clock, a variable optical delay line that controls the phase of the optical clock, a first optical splitter that feeds back some of the optical clock to the laser unit and outputs the remaining optical clock, and a second optical splitter that combines the optical clock, the phase of which is controlled by the variable optical delay line, with the optical signal provided from the optical signal controller and provides the combined signal to the laser unit disposed on a rear end of the variable optical delay line.

Also, the optical regeneration loop may further include a polarization controller, disposed between the first and second optical splitters, that controls the polarization state of the feedback optical clock.

### BRIEF DESCRIPTION OF THE DRAWINGS

The above and other features and advantages of the present invention will become more apparent by describing in detail exemplary embodiments thereof with reference to the attached drawings in which:

FIGS. 1 and 2 are schematic block diagrams of a conventional system for an all-optical clock recovery; and

FIGS. 3 and 4 are block diagrams of embodiments of a system used for all-optical clock recovery and having an optical regeneration loop, according to the present invention.

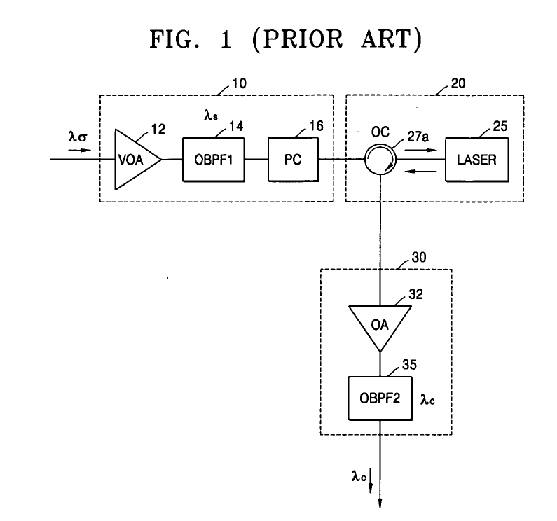

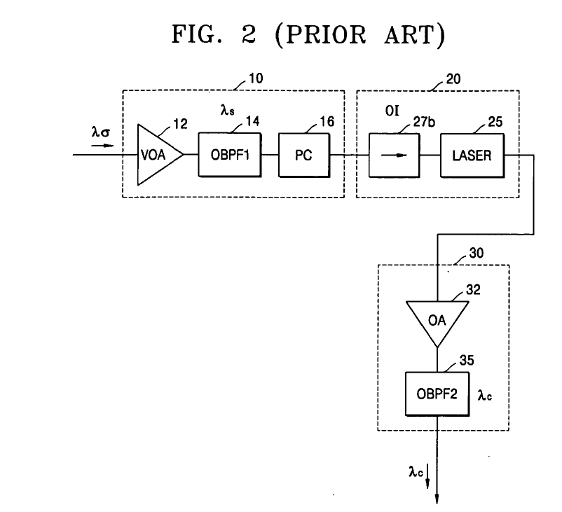

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. Throughout the drawings, like reference numerals refer to like elements.

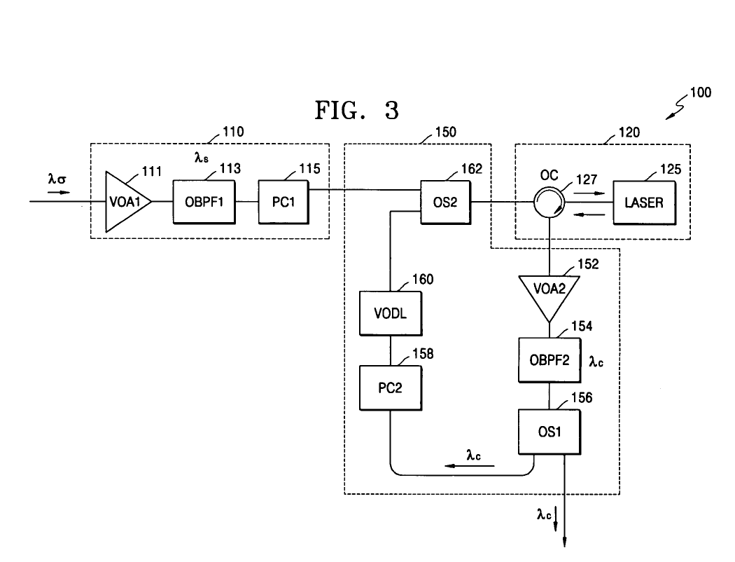

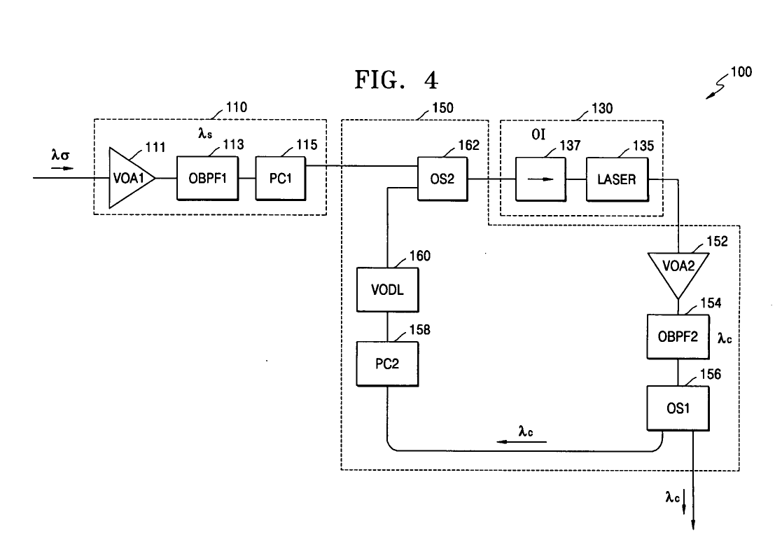

Referring to FIGS. 3 and 4, an all-optical clock recovery device according to embodiments of the present invention includes an optical signal controller 110, a laser unit (120 or 130), to which an optical signal controlled by the optical signal controller 110 is input, and an optical regeneration loop 150 that controls the phase, polarization, and strength of an optical clock output by the laser unit (120 or 130) and provides the laser unit (120 or 130) with the optical clock and the optical signal.

Here, the optical signal controller 110 includes a first variable optical amplifier (VOA) 111 that controls the strength of optical signals, a first optical bandpass filter (OBPF) 113 that transmits an optical signal with a desired wavelength, the strength of which is controlled, and a first polarization controller (PC) 115 that controls the polarization state of the filtered optical signal. Here, the first PC 115 may or may not be required depending on the type of laser used.

Laser units 120 and 130 include lasers 125 and 135, respectively. Here, the lasers 125 and 135 can have a common input and output port, as shown in FIG. 3, or different input and output ports, as shown in FIG. 4. The lasers 125 and 135 may be, for example, a passively mode-locked laser diode, a mode-locked fiber ring laser, or a self-pulsating laser diode.

In a case where the input and output ports of the laser 125 are the same, the laser unit 120 includes an optical circulator (OC) 127 that designates the proceeding direction of the optical clock, as shown in FIG. 3. The OC 127 is installed on a front end of the laser 125 to pass the input optical signal and/or the optical clock in one direction only. In a case where the input and output ports of the laser 135 are different, the laser unit 130 includes an optical isolator (OI) 137 that passes the input optical signal and/or the optical clock in one direction, as shown in FIG. 4. If the optical clock proceeds towards both directions of an optical regeneration loop, the phase (or timing) and polarization state of the optical clocks traveling in different directions may be different from each other in the lasers 125 and 135, which would negatively affect clock recovery. In other words, the OC 127 and the OI 137 enable the optical signal and the optical clock output from the laser to proceed in a clockwise direction of the optical regeneration loop 150 and not return to the optical signal controller 110.

The optical regeneration loop 150 includes a second VOA 152 that controls the strength of the optical clock output from the laser unit (120 or 130), a second OBPF 154 that passes only the optical clock among the optical signal and the optical clock, and a first optical splitter (OS) 156 that feeds back some of the optical clock filtered by the second OBPF 154 to the laser unit (120 or 130) and outputs the rest of the optical clock. Additionally, the optical regeneration loop 150 includes a second PC 158 that controls the polarization state of the optical clock that is returned to the laser unit (120 or 130) by the first OS 156; a variable optical delay line (VODL) 160 that controls the phase of the optical clock, the polarization state of which is controlled by the second PC 158; and a second OS 162 that combines the optical clock, the phase of which is controlled by the VODL 160, with the optical signal provided from the optical signal controller 110 and provides the laser unit (120 and 130) with the combined signal. The second PC 160 may or may not be required depending on the type of laser used.

Operations of the all-optical clock recovery device having the above structure will be described below.

The magnitude of the optical signals λ_{σ} is controlled and the optical signal with a desired wavelength is transmitted within the optical signal controller 110, for example, by the first VOA 111 and the first OBPF 113. Here, λ_{S} denotes the selected wavelength. The filtered optical signal is input into the first PC 115, which controls the polarization state of the filtered optical signal, and is passed to the laser (125 or 135) of the respective laser unit (120 or 130) after first being passed through the second OS 162.

The laser (125 or 135) outputs the optical clock due to the input optical signal. Here, in a case where the input and output ports of the laser 125 are the same, the OC 127 provides the laser 125 with the input optical signal and transmits the optical clock output from the laser 125 to the optical regeneration loop 150. In a case where the input and output ports of the laser 135 are different, the OI 137 transmits the optical signal output from the optical signal controller 110 to the laser 135 and prevents the optical clock and the optical signal output from the laser 135 from being transmitted in a reverse direction so that the optical clock and the optical signal proceed in only one direction of the optical regeneration loop 150.

The strength (magnitude) of the optical clock output from the laser unit (120 or 130) is controlled by the second VOA 152, and only the optical clock is passed by the second OBPF 154 with the optical signal filtered off. The optical clock is split by the first OS 156 into one part that will be output and the other that will be looped back. Accordingly, the OS 156 either outputs the optical clock kc or passes the optical clock λ_{C} to the second PC 158 which controls the polarization state of the optical clock λ_{C}. The VODL 160 controls the optical clock % c such that its phase coincides with that of the optical signal input by the optical signal controller 110. In addition, the optical clock, the phase of which is controlled, is combined with the optical signal from the optical signal controller 110 by the second OS 162, and the combined signal is provided to the laser unit (120 or 130). Since the optical clock, as well as the optical signal, are input to the laser unit (120 or 130), a pattern effect and timing jitter of the optical clock output from the first OS 156 can be reduced.

As described above, according to the present invention, an optical clock with reduced pattern effect and timing jitter can be recovered using an optical regeneration loop without the need for electrical-to-optical conversion or optical-to-electrical conversion. In addition, the optical clock recovered from the optical signal can be used to process the optical signal.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A system for all-optical clock recovery comprising:
an optical signal controller that controls the magnitude and the polarization state of an optical signal;
a laser unit that receives the optical signal output from the optical signal controller and outputs an optical clock; and
an optical regeneration loop that controls the phase, polarization, and magnitude of the optical clock output from the laser unit so as to provide the laser unit with the optical clock, the phase, polarization, and magnitude of which are controlled, and the optical signal output from the optical signal controller.

2. The system of claim 1, wherein the optical signal controller comprises:
a variable optical amplifier that controls the strength of the optical signal; and
an optical bandpass filter that filters the optical signal with a desired wavelength.

3. The system of claim 2, further comprising a polarization controller, that controls the polarization state of the optical signal.

4. The system of claim 1, wherein the laser unit comprises a laser and a unit for transmitting the optical clock output from the laser to the optical regeneration loop.

5. The system of claim 4, wherein if the input and output ports of the laser are the same, the unit for transmitting the optical clock is an optical circulator.

6. The system of claim 4, wherein if the input and output ports of the laser are different, the unit for transmitting the optical clock is an optical isolator.

7. The system of claim 1, wherein the optical regeneration loop comprises:
a variable optical amplifier that controls the magnitude of the optical clock output from the laser unit;
an optical bandpass filter that filters the optical clock from the optical signal and clock;
a variable optical delay line that controls the phase of the optical clock.
a first optical splitter that feeds back some of the optical clock filtered by the optical bandpass filter to the laser unit and outputs the remaining optical clock; and
a second optical splitter that combines the optical clock, the phase, polarization, and magnitude of which are controlled, with the optical signal provided from the optical signal controller and provides the combined signal to the laser unit.

8. The system of claim 7, further comprising a polarization controller, that controls the polarization state of the feedback optical clock.
